(19) United States
(12) Patent Application Publication
(10) Pub. No.: US 2026/0344585 A1
(43) Pub. Date: Nov. 5, 2026

(54) ROOT BARRIER

(71) Applicants: TOM SMITH, ANAHEIM, CA (US); LOGAN SMITH, ANAHEIM, CA (US)

(72) Inventors: TOM SMITH, ANAHEIM, CA (US); LOGAN SMITH, ANAHEIM, CA (US)

(21) Appl. No.: 19/714,301

(22) Filed: Jun. 19, 2026

Related U.S. Application Data
(63) Continuation-in-part of application No. 18/665,230, filed on May 15, 2024.

(51) Int. Cl. A01G 9/28

(52) U.S. Cl. CPC A01G 9/28

(57) ABSTRACT

A root barrier panel manufactured as a continuous flexible polyethylene roll carries a three-stage copper deterrence system. The panel has a middle warp acting as a leaf spring that biases pinch ribs into engagement with an adjacent panel at notch and groove connectors, and a flexible lower edge that deforms and anchors the panel when roots grow beneath it. A chitosan-copper sulfate spray layer and or copper particulate coating layer are deposited on a micro-ridge surface architecture on the interior surface. The copper particulate coating comprises copper particles at 2.5 to 10 percent by weight in an acrylic, alkyd, or polyurethane binder dissolved in an organic solvent carrier comprising toluene, petroleum naphtha, or dimethyl carbonate. Upon curing, the binder encases most of the copper particles within the polymer matrix and over the service life of the barrier, copper is progressively exposed through dissolution of surface particles.

The present application is a continuation-in-part of and claims priority from copending U.S. patent application Ser. No. 18/665,230, filed May 15, 2024, entitled Root Barrier, the entire disclosure of which is incorporated herein by reference.

### TECHNICAL FIELD

The present disclosure relates to root barriers.

### BACKGROUND

Invasive plant root growth causes substantial damage to sidewalks, building foundations, underground utility conduits, sewer and drain systems, and irrigation infrastructure. Root barriers have been developed to redirect or deter root growth away from structures and installations. Traditionally, root barriers have been made of 100% high density polyethylene which makes the root barriers fairly rigid and for long-lasting robust capability. Unfortunately, these root barriers lift out of the ground and are not barefoot safe.

A variety of different structures have improved root panels, for example, in U.S. Pat. No. 7,810,275, entitled Root Growth Barrier and Method, states, “The present invention provides an improved root growth barrier formed by two layers bonded to one another to form a bilayer material. The root growth barrier comprises a thin root-tip-trapping layer that traps or catches the root tips and a layer consisting of a root-impenetrable material formed onto a surface of the root-tip-trapping layer.”

Some copper based biological deterrents would not work for roots, for example, in United States patent publication WO2014/055418, entitled Copper-Based Antifouling Composition, states a composition containing copper flake incorporated into an acrylic resin binder which would work for marine antifouling coatings for boat propellers and hulls but not for application to a polyethylene root barrier substrate. Other root barrier products including those manufactured under the Biobarrier trademark use trifluralin herbicide contained in nodules on a geotextile fabric but these risk ground contamination and do not last for many years on the timescale of large tree root growth.

### SUMMARY OF THE INVENTION

A multi-stage copper-based chemical deterrence system delivers copper ions in a targeted, controlled manner specifically in response to root exudate activity, while minimizing copper leaching into the surrounding bulk soil and minimizing cost. The system applies copper particulate coating to the surface of a flexible polyethylene root barrier panel manufactured as a continuous roll using one of two spray application modes: aerosol spray application, suitable for field installation and small-scale production, or air-spray gun application without propellant, suitable for inline industrial roll-to-roll manufacturing. Both modes deliver the same copper particulate coating formulation comprising copper particles suspended in a polymer binder dissolved in an organic solvent carrier, and both deposit the same copper deterrence layer on the panel surface.

A root barrier panel manufactured as a continuous flexible polyethylene roll optionally carries a three-stage copper deterrence system. The panel has a middle warp acting as a leaf spring that biases pinch ribs into engagement with an adjacent panel at notch and groove connectors, and a flexible lower edge that deforms and anchors the panel when roots grow beneath it. A chitosan-copper sulfate spray layer and or copper particulate coating layer are deposited on a micro-ridge surface architecture on the interior surface. The copper particulate coating comprises copper particles at 2.5 to 10 percent by weight in an acrylic, alkyd, or polyurethane binder dissolved in an organic solvent carrier comprising toluene, petroleum naphtha, or dimethyl carbonate. The copper particulate coating is applied either by aerosol spray in which propane and n-butane propellant atomizes the formulation for portable field or job-site application or by air-spray gun without propellant for inline industrial roll-to-roll manufacturing. Upon curing, the binder encases most of the copper particles within the polymer matrix, leaving only a surface fraction exposed for immediate deterrence. Over the service life of the barrier, additional copper is progressively exposed through dissolution of surface particles, ionic diffusion through the binder, and binder weathering, providing sustained release over years. As an optional final step after copper particulate coating curing, a copper wool applicator mechanically abrades the outermost binder skin to immediately expose a higher fraction of copper particles, providing faster initial deterrence where early root challenge is expected.

A key inventive feature is that the copper particulate coating is applied not only to the exterior soil-facing surface of the panel but also to the interior faces of the notch and groove connectors, namely the first notch and groove connector and the second notch and groove connector at the panel right rib and panel left rib, which are the surfaces that face inward after two panels are interlocked. Root tips most commonly attempt to penetrate the barrier by exploiting the joint seam between adjacent panels. By coating the interior connector surfaces with copper particulate coating before the panels are joined at the job site, root intrusion through the connector joint is chemically deterred even after the panels are mechanically interlocked and the coated surfaces are facing inward toward each other.

The following design is to keep the root barrier panels from sliding up out of the ground. The base of the panel will flare, making a parachute effect or land lock all made possible due to the flexible material, the product is made from roughly half low-density polyethylene and half high-density polyethylene. Soil will add friction on the panel and prevent it from sliding upward, as well as locking it in place, as a root grows bigger due to the spring flexible nature of the panel interaction.

The top edge of the root barrier is designed thin to not be so visible from above grade, unlike traditional root barrier the thin polyethylene edge is made from a material that is flexible and is able to bend and fold to be barefoot safe. A top safety edge is less visible on landscaping but is still barefoot safe.

The inverted ribs are designed to have two different functions with one side designed to catch the root and keep the root from sliding sideways along the panel, directing the root either up or down. The inverted portion of the rib on the other side is designed to stop the root and direct it either up or down, this way, the material can be planted with either direction toward the root ball and successfully direct the roots to prevent root girdling on newly planted shrubs or trees.

The new rib material is designed to lock one rib into the other, and is being held by friction. The soil is packed tightly on both sides of the barrier, locking the product panel, the panel, an anti-friction movement product the tighter the soil is packed the tighter, the panels are locked together, making them inseparable and preventing any areas for roots to penetrate the product. The root barrier panels are made from a unique blend of polyethylene. This allows this material to be very flexible, but yet not crack or tear from the stress being applied to it from the existing trees we are made from a 50% post industrial low density polyethylene, and a 50% High density post industrial polyethylene with 3% carbon mix.

The hydraulic folding application of this machine allows two vertical ribs to be placed within the machine at the same time while the base is moved upward to lock material in place after material has been heated to approximately 290° the machine will fold downward, and the carrier will move forward, approximately 6 inches to allow the set up for the next set of ribs to be applied all done while locking the material in place. The Hydraulic folding is being cooled through a chilled water injection throughout aluminum blocks. A carrier cam moves backwards to set up for the next fold on material. The vertical ribs are the important factors that both sides of the material can be used to lock ribs to roots. The angles on these ribs should be 40 to 90°. The material is a multipurpose, material, a water barrier and a root barrier, all in one unique design with leaf spring soil friction locks.

The root barrier has an inner panel with an inner panel middle warp. An inner panel lower edge and an inner panel upper edge formed on the inner panel. An inner panel right edge, and an inner panel left edge are formed on the inner panel. An inner panel right rib are formed on the inner panel right edge and an inner panel left rib is formed on the inner panel left edge. The inner panel right rib is formed as a first pinch rib and the inner panel left rib is formed as a second pinch rib. The first pinch rib and the second pinch rib are both configured to connect with an outer panel by nesting the pinch ribs that pinch to each other. The outer panel and the inner panel form a panel overlap. A parallel portion is formed along the panel overlap. The parallel portion has a panel gap. The inner panel right rib forms a first inner pinch retainer. The panel left rib forms a second inner pinch retainer. The first inner pinch retainer is formed as a first notch and groove connector. The second inner pinch retainer is formed as a second notch and groove connector.

The outer panel preferably has a copper particulate coating layer deposited on the corona-treated surface by spray application. The copper particulate coating layer has copper particles at 2.5 to 10 percent by weight suspended in a polymer binder dissolved in an organic solvent carrier. The polymer binder, upon solvent evaporation, forms a cured film that encases the copper particles such that a surface fraction of the copper particles is exposed at the film surface at the time of application.

The inner panel is flexible and acts as a leaf spring to bias end connections. The inner panel middle warp is resilient and can be flattened along the panel overlap when compressed together in an installed mode. The inner panel is formed with a flexible panel lower edge. The inner panel is configured to deform when a root grows under the inner panel. The inner panel is formed of at least 40% low-density polyethylene by weight, 40% high density polyethylene by weight, and at least 2% carbon. The inner panel right rib is V-shaped and the panel left rib is also V-shaped.

The outer panel also has an outer panel middle warp. An outer panel lower edge and an outer panel upper edge are formed on the outer panel. An outer panel right edge, and an outer panel left edge are formed on the outer panel. The outer panel right rib is formed on the outer panel right edge and the outer panel left rib is formed on the outer panel left edge. The outer panel right rib is formed as a first pinch rib and the outer panel left rib is formed as a second pinch rib. The inner panel is flexible and acts as a leaf spring. The inner panel middle warp is resilient and can be flattened along the panel overlap when compressed together in an installed mode.

The inner panel is formed with a folding machine which has a first forming bar and a second forming bar. The second forming bar is mounted after the first forming bar at a set distance from the first forming bar. A first heater is mounted to the first forming bar and a second heater mounted to the second forming bar. A first swivel arm forms the first pinch rib at a first forming gap and a second swivel arm forms the second pinch rib at a second forming gap. The first heater and the second heater heat a material feed to form a middle warp on the panel between the inner panel right rib and the inner panel left rib.

The polyethylene substrate of the panel contains copper oxide nanoparticles dispersed throughout the substrate and encapsulated in a biodegradable pH-responsive encapsulant. The panel surface further receives copper particulate coating applied by aerosol spray can or by air-spray gun to deposit a copper deterrence layer on both the exterior soil-facing surface and the interior connector surfaces. The pH-responsive encapsulant releases copper ions in response to root-induced acidification of the soil environment proximate to the barrier, creating a three-stage temporal copper release architecture providing immediate, medium-term, and long-term deterrence from a single panel product.

### BRIEF DESCRIPTION OF THE DRAWINGS

FIG. 1 is a diagram showing the panel lower edge deforming as a root grows beneath it.

FIG. 2 is a diagram showing an inside panel of the present invention.

FIG. 3 is a diagram showing an outer panel connecting with an inner panel.

FIG. 4 is a diagram showing the folding machine.

FIG. 5 is a diagram showing a side view of the folding machine.

FIG. 6 is a side view of the panel at the notch and groove connector region showing the micro-ridge surface architecture.

FIG. 7 is a bottom cross section view of the panel.

FIG. 8 is a diagram showing the panel lower edge directing the root downwards.

FIG. 9 is a diagram showing an inside panel of the present invention.

The following call out list of elements can be a useful guide in referencing the element numbers of the drawings.
20 panel
21 panel upper edge
22 panel lower edge
23 panel right edge
24 panel left edge
25 flexible bottom portion
26 deformation area
27 panel right rib
28 panel left rib
29 lower edge
30 adjacent panel
31 outer panel
32 inner panel
33 panel overlap
34 first notch and groove connector
35 second notch and groove connector
36 first pinch retainer
37 second pinch retainer
38 parallel portion
39 roll end
40 rib forming frame
41 first linear actuator
42 second linear actuator
43 first forming bar
44 second forming bar
45 first swivel arm
46 second swivel arm
47 first forming gap
48 second forming gap
49 material feed
50 material roll
51 front base
52 rear base
53 first hinge
54 second hinge
55 first heater blade
56 second heater blade
57 first heater
58 second heater
59 forming die
60 pinch rib spring connection
61 first pinch rib
62 second pinch rib
63 material bend
88 middle warp
89 panel gap
128 tree root
200 polyethylene substrate
202 micro-ridge surface architecture
204 ridge
206 ridge peak
208 ridge channel
210 ridge face
212 ridge height (H)
214 ridge base width (W)
216 center-to-center spacing
220 copper oxide nanoparticles
222 chitosan-alginate polyelectrolyte complex encapsulant
230 copper particulate coating
232 chitosan chelation layer
234 binder-matrix layer
236 binder-matrix interior layer
238 encapsulated nanoparticle layer
240 corona discharge electrodes
242 activated surface layer
244 aerosol spray can applicator
246 air-spray gun applicator
248 copper wool abrading applicator
249 abraded surface zone with exposed copper
250 root tip
252 root meristematic zone
254 rhizosphere acidification zone

### DETAILED DESCRIPTION OF THE EMBODIMENTS

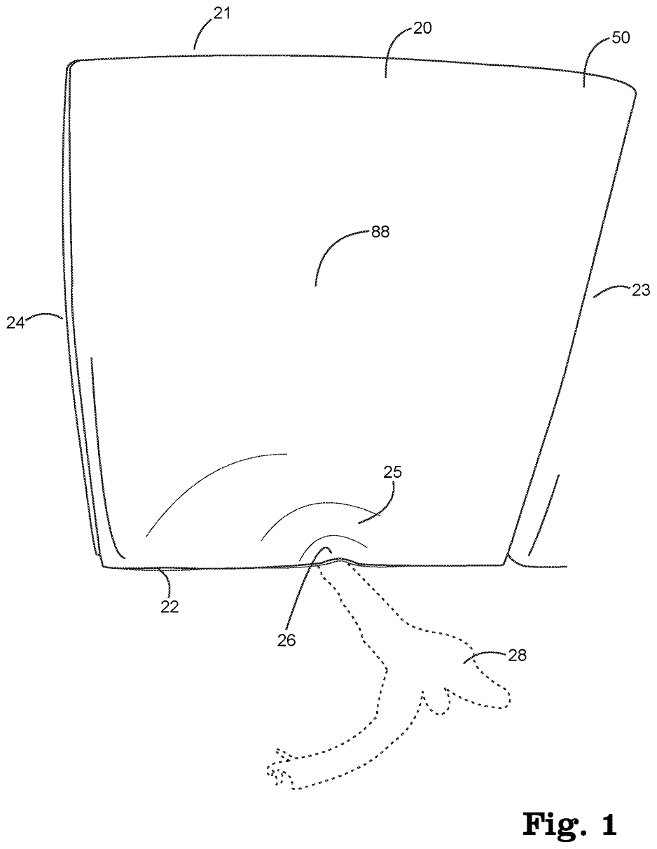

As shown in FIG. 1, the following root barrier is designed to retain itself from sliding up out of the ground over time. As a root grows underneath the root barrier, a bottom edge of the panel will flare and deform which acts as a retainer or lock and thus anchor the root barrier to the ground. The root barrier is made of a flexible material such as a plastic sheet such as medium density polyethylene. The material is preferably a blended material of low density and high density polyethylene. The typical material used for root barriers can be softened so that the root barriers have a flexible bottom portion 25. The flexible bottom portion 25 allows a deformation area 26 when a plant root or tree root 128 grows underneath the root barrier. The panel 20 of the repair includes a panel upper edge 21 that may be exposed and not buried. The panel 20 also includes a panel right edge 23 and the panel left edge 24 which can be continuous with other panels to be joint into a sheet or roll. The panel lower edge 22 of the panel 20 has the flexible bottom portion 25. Preferably, a middle warp 88 is also introduced such that the panel 20 is not flat, but rather has an undulation. The middle warp 88 travels from the panel right edge 23 to the panel left edge 24 to create a curved spring tension for locking the vertical edges. The panel right edge 23 and the panel left edge 24 both have a slight bend to it given by the middle warp 88. The bend on the panel right edge and the panel left edge allow the panels to lock up to each other when necessary.

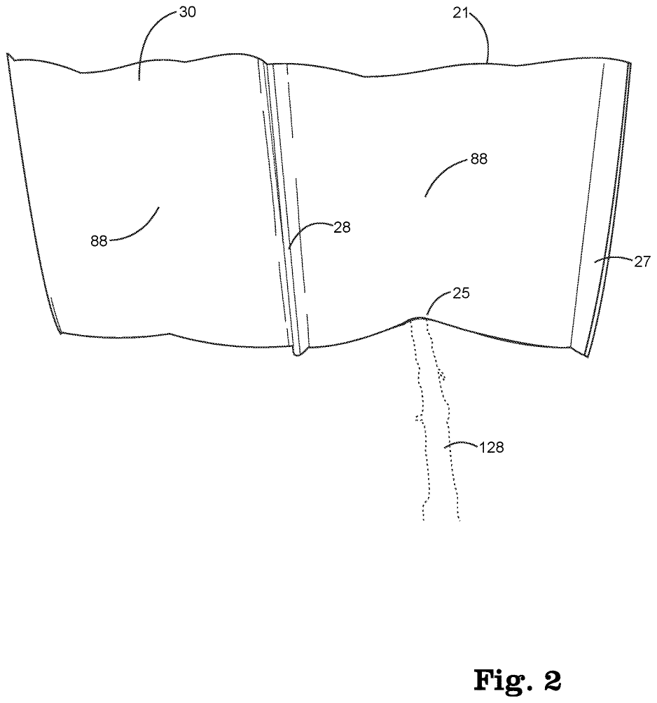

As seen in FIG. 2, the panel upper edge 21 is also undulating, the undulation of which is exaggerated as shown in the figure. The adjacent panel 30 also has a middle warp 88. The middle warps 88 are flexible and behave as springs for locking the panel into the ground. When the tree root 128 grows under the flexible soft portion 25, the deformation at the flexible soft portion 25 can be continued to the middle warp 88 such that the panel right rib 27 and the panel 28 lock to the ground. The flexible soft portion 25 has a deformation when a tree root 128 grows under it. The deformation can be concave or convex and the deformation of the middle warp 88 can also be concave or convex. Typically, the flexible bottom portion 25 would have a concave deformation and the middle warp 88 would also have a concave deformation. The concave deformations act as a leaf spring such that the panel acts as a leaf spring for locking to the ground.

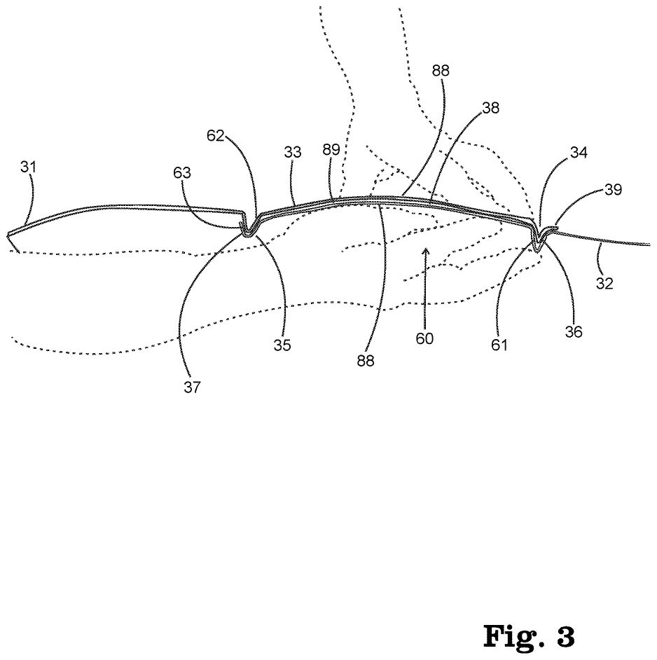

As seen in FIG. 3, the panels lock together as the undulations form a parallel portion 38 having a middle warp 88 on the panel overlap portion 33. The panel overlap portion has a first pinch retainer 36 and a second pinch retainer 37. The first pinch retainer 36 uses the groove of the inner panel 32 such as the first notch and groove connector 34 and the second notch and groove connector 35. The panel right rib 27 and the panel left rib 28 of the outer panel 31 and the inner panel 32 locked together to form the first notch include connector 34 and the second notch and groove connector 35. As the user pushes the panels together, the middle warps 88 of each of the panels create a panel gap 89 in between the panels. The leaf spring nature of the panel gaps 89 creates a locking force at the panel right ribs 27 and the panel left ribs 28 such that they lock together with a spring force especially when buried.

Undulations will add friction on the panels and prevent them from sliding upward since they are biasing away from each other such as to wedge themselves in the ground or soil. The undulations are uneven, and become more parallel when dirt is filled on both sides to push them together. After the panels are locked in place, as a root grows bigger, the root deforms the lower flexible portion which further locks the panel in place. During an unburied portion of the assembly, a user pushes the V shaped ribs into each other to build a temporary structure where the uneven right panel ribs and left panel ribs have spring force due to the middle warp 88. The warp spring force provides a retaining force that holds the ribs to each other. After the barrier is buried in the ground, the panel gap 89 is closed which further provides a spring force where the outer panel 31 pushes outwardly and the inner panel 32 pushes inwardly so as to wedge the parallel portion 38 firmly. The material bend 63 also acts as a spring which locks the panels together. The panel gap 89 is exaggerated for clarification. The parallel portion 38 is generally curved, but appears fairly straight and parallel when seen in a close-up view.

The top edge of the root barrier can be thin to not be so visible from above grade. The root barrier can be thinner than 80 mil and preferably less than 65 mil thick. A thin polyethylene edge is made from a material that is very flexible and can bend and fold to prevent damage to feet. The top portion remains flexible so that the top safety edge is not seen on the landscaping. As the top edge is flexible, it is step safe if users step on it with bare feet. A variety of methods can be used to soften and make flexible the existing root barrier material. Having a flexible material creates a spring flex that provides both a safety feature at the top edge, a retaining feature at the bottom edge and a retaining feature in the middle of the panel.

The panel also has inverted ribs are designed to have two different effects on one side it is designed to catch the root and keep the route from sliding sideways along the panel, directing the route either up or down. The inverted portion of the rib on the other side is designed to stop the root and direct it either up or down. This way the material can be planted with either direction toward the root ball and successfully direct the roots to prevent root gurgling on newly planted shrubs or trees. The inverted ribs connect with each other when pressed together. The new rib material is designed to lock one rib into the other, and is being held by friction and tension. The soil is packed tightly on both sides of the barrier, locking the product panel, the panel, an anti-friction movement product. The soil pack tightens the connection between the panels when the panels are locked together. This makes the panels inseparable and prevents any areas for roots to penetrate the product.

To provide the flexible material that allows the connection of the ribs and warp connection, the root barrier panels are preferably made from a unique blend of polyethylene. The best mode known to date allows the material to be a flexible, but yet not crack or tear from the stress being applied to it from existing trees, which is a 50% post industrial low density polyethylene, and a 50% high density post industrial polyethylene with 3% carbon mix. When other material is being mixed in, the low-density polyethylene is preferably at least 40%, and the high density polyethylene is at least 40%, and the carbon mix is at least 2%. The carbon mix can be a graphite carbon black which can be helpful for ultraviolet resistance. This creates the pinch rib spring connection 60 formed between the first pinch retainer 36 and the second pinch retainer 37.

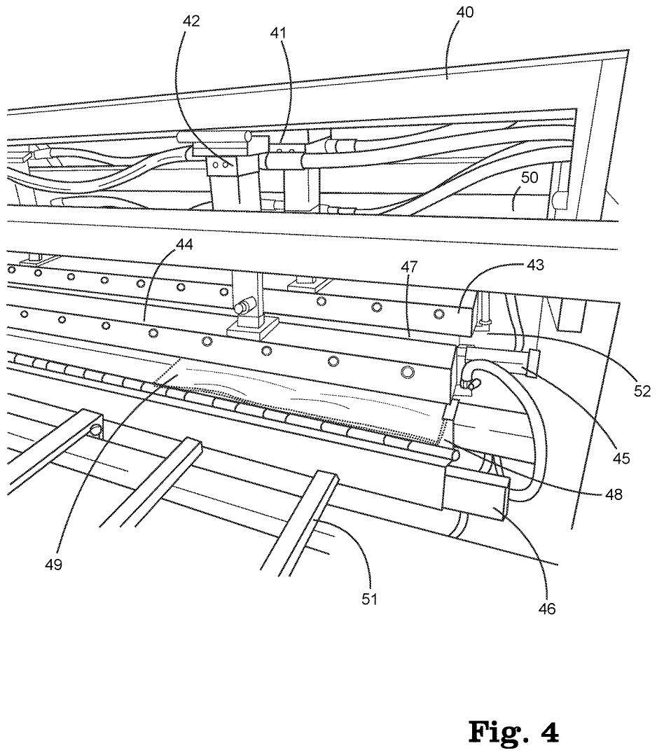

As seen in FIG. 4, the hydraulic folding application of this machine allows two vertical ribs to be placed within the machine at the same time while the base is moved upward to lock material in place after material has been heated to approximately 290°. The machine will fold downward, and the carrier will move forward, approximately 6 inches to allow the set up for the next set of ribs to be applied. This is all done while locking the material in place as the carrier moves backwards to set up for the next fold of material. The vertical ribs are formed to connect with each other when overlapped such that both sides of the material can be used to lock the ribs with each other. The angles on the ribs should be 40° to 90°. The material can be provided in a roll and can be used for multiple purposes including a water barrier and a root barrier, with soil friction locks. The folding machine includes a rib forming frame 40 retaining a first linear actuator 41 and a second linear actuator 42, while the material feed 49 runs through the folding machine. The first linear actuator 41 actuates the first forming bar 43. The second linear actuator 42 actuates a second forming bar 44. The first forming bar 43 pushes material into a first forming gap 47. The second forming bar 44 pushes material into a second forming gap 48. The first forming bar 43 and the second forming bar 44 have heaters such as electrical resistance heaters that heat the material feed 49 and create undulations in the material so that the material is not perfectly flat and slick. The front base 51 receives the material feed 49, and the rear base 52 supports the rear portion of the material feed 49 that feeds from the material roll 50. The ribs are created with a first swivel arm 45 making a first fold and the second swivel arm 46 making a second fold.

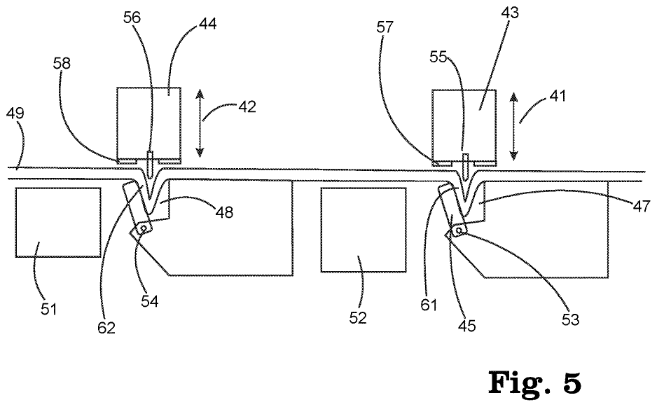

As seen in FIG. 5, the material feed 49 travels to the left. The first heater 57 is spaced apart from the second heater 58. The first heater 57 heats the material under the first heater blade 55 and the second heater heats the material under the second heater blade 56. The first heater blade 55 presses the material down to form a first pinch rib 61 and the second heater blade 56 presses material down to form a second pinch rib 62. The first linear actuator 41 actuates and raises and lowers the first heater blade 55, and the second linear actuator 42 raises and lowers the second heater blade 56. The first swivel arm 45 presses the first pinch rib in a first forming gap 47. The second swivel arm 46 presses the second pinch rib 62 in a second forming gap 48. The first forming bar 43 and the second forming bar 44 are spaced apart from each other to define a panel section on the material feed 49. The rear base 52 and the front face 51 hold the material feed 49 as the material feed slides forward. The first swivel arm 45 is mounted on a first hinge 53 and the second swivel arm 46 is mounted on a second hinge 54.

After the material feed is transformed into root barrier panels, the root barrier panels are rolled for storage and later brought to the job site. At the jobsite, a user can cut the root barrier panels and press the panels together to connect them. The panel connection method does not require tools or connectors such as staples, bolts or the like. The panel connection method only requires a blade for cutting the panel. The root barrier panels can circumscribe a tree or young planting for example. Initially, roots are not touching the root barrier panels. In the installed mode, the panels are pressed together and have a spring tension that expands outwardly to try to create a gap. The panels are not congruent, such that the middle warp of each panel does not align exactly. Thus, as the panels are formed as springs, the springs press outwardly to form a gap. Panel material is preferably an A-46 black postindustrial polyethylene regrind mix in the range of 0.960 g/cm³ with a melt flow of 0.3 g/10 min and a hardness of 95R.

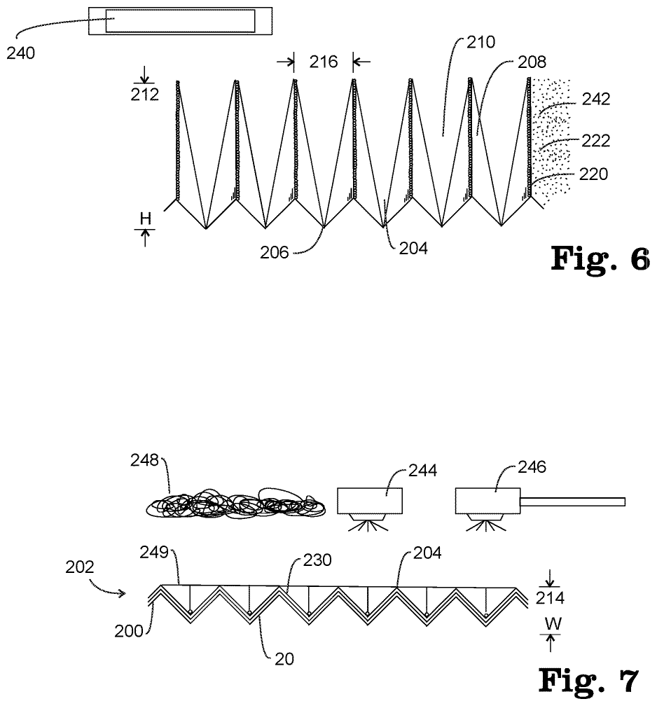

As seen in FIG. 6, a side view of the panel 20 at a straight portion of the panel and shows the polyethylene substrate 200 and the micro-ridge surface architecture 202 formed on the exterior surface. The micro-ridge surface architecture 202 is formed not only on the flat face of the panel 20 but also on the exposed faces of the first notch and groove connector 34 and the second notch and groove connector 35 at the panel right rib 27 and the panel left rib 28. Each ridge 204 of the micro-ridge architecture has a ridge peak 206 and is separated from adjacent ridges by a ridge channel 208. The ridge height 212, designated H in FIG. 6, is 0.1 to 2.0 millimeters extends upwardly from the panel lower edge 22 on the base surface of the polyethylene substrate 200. The ridge channels have a depth of preferably 0.3 to 0.8 millimeters. The ridge base width 214, designated W, is 0.2 to 3.0 millimeters. The center-to-center spacing 216 is 0.3 to 5.0 millimeters. The ridge channels 208 concentrate root tip contact at the ridge faces 210 and channel floors, which are the locations where the copper particulate coating layer 230 will be most effective.

FIG. 6 also shows a side view of the lower edge of the panel showing copper oxide nanoparticles 220 distributed as dots throughout the cross-section of the polyethylene substrate 200, each encapsulated in chitosan-alginate polyelectrolyte complex encapsulant 222. The encapsulant 222 holds the nanoparticles intact within the substrate at neutral or alkaline soil pH. The corona discharge electrode 240 has passed over the panel surface immediately prior to copper particulate coating application, producing the activated surface layer 242 visible in FIG. 6 as a thin polar interface at the outer surface of the polyethylene substrate 200. The corona discharge electrode 240 operates at 10 to 100 kilohertz and 5 to 15 kilovolts, raising the polyethylene surface energy from approximately 31 to 33 dynes per centimeter to at least 38 dynes per centimeter by introducing carbonyl, hydroxyl, and carboxyl polar functional groups at the surface. This activated surface layer 242 may promote adhesion of the copper particulate coating to the polyethylene substrate 200.

The activated surface layer 242 is present on both the surface of the panel 20 and on the interior surfaces of the first notch and groove connector 34 and the second notch and groove connector 35. The interior surfaces of these connectors are the surfaces that will face inward and press against the corresponding surfaces of the adjacent panel 30 after interlocking. These interior connector surfaces are a primary pathway for root intrusion because any gap or imperfection at the panel joint provides an entry point for root tips seeking to penetrate the barrier. The corona activation and copper particulate coating application to these interior surfaces, before panel interlocking at the job site may place a copper deterrence layer at this zone.

As seen in FIG. 7, the panel surface of FIG. 6 is shown following copper particulate coating 230 application to the polyethylene substrate 200. The copper particulate coating 230 is can be applied in two sequential passes using either an aerosol spray applicator 244 or an air-spray applicator 246, both of which are shown in FIG. 7 as alternative means of depositing the same copper particulate coating formulation on the same panel surfaces. The copper particulate coating formulation used in both application modes comprises copper particles (CAS No. 7440-50-8) at 2.5 to 10 percent by weight as the active deterrent ingredient, suspended in a polymer binder system dissolved in an organic solvent carrier. The binder is an acrylic polymer, alkyd resin, or polyurethane resin. The acrylic binder is preferred for single-component formulations because it cures by solvent evaporation at ambient temperature without requiring a co-reactant, adheres to corona-treated polyethylene and to the micro-ridge surface architecture 202, and remains flexible after curing so that the panel 20 can be rolled, unrolled, cut, and bent at the job site without cracking the copper particulate coating layer 230. The organic solvent carrier comprises one or more of toluene (CAS No. 108-88-3), petroleum naphtha hydrotreated light grade (CAS No. 64742-49-0), dimethyl carbonate (CAS No. 616-38-6), hydrotreated light distillate (CAS No. 64742-47-8), n-heptane (CAS No. 142-82-5), or octane (CAS No. 111-65-9), which dissolve the binder resin, control the viscosity of the copper particulate coating for spray application, and evaporate after deposition to leave a dried copper-binder film on the panel surface.

In the aerosol spray application mode, the copper particulate coating formulation is packaged in a pressurized container with a hydrocarbon propellant comprising propane (CAS No. 74-98-6) at 10 to 25 percent by weight and n-butane (CAS No. 106-97-8) at 10 to 25 percent by weight. The propellant keeps the contents under pressure and atomizes the copper particulate coating as a fine mist upon actuation of the valve. The aerosol spray applicator 244 is portable, requires no external compressed air source. The installer can apply copper particles with a nozzle 6 to 12 inches from the panel surface, and applies the copper particulate coating to the exterior soil-facing surface including the micro-ridge surface architecture 202, and then directs the aerosol nozzle into the open groove of the first notch and groove connector 34 and the second notch and groove connector 35 to coat the interior connector surfaces before pressing the adjacent panel 30 into engagement. Aerosol application can be used for job-site use and retrofit application to panels already cut to length. The aerosol spray applicator 244 does not require thinning of the formulation and delivers consistent atomization independent of ambient air pressure.

In the air-spray gun application mode, the same copper particulate coating formulation is used in liquid form without propellant. The propane and n-butane propellants present in the aerosol format are absent. The copper particulate coating is supplied in a bulk liquid container and is thinned if necessary with additional toluene or petroleum naphtha to achieve a viscosity of 15 to 30 seconds measured in a No. 4 Ford Cup, which is suitable for atomization by a conventional HVLP (high-volume low-pressure) or conventional air spray gun at an air pressure of 20 to 50 pounds per square inch at the gun inlet. The air-spray gun applicator 246 is integrated into the inline roll-to-roll manufacturing process: the panel 20 passes under a fixed spray boom carrying multiple air-spray nozzles aimed at the exterior soil-facing surface and at angled nozzles directed into the groove channels of the first notch and groove connector 34 and the second notch and groove connector 35. Air-spray application allows precise control of film thickness, copper coverage uniformity, and solvent flash-off time in a ventilated production environment. Air-spray application is preferred for factory production of copper-treated panel rolls because it is continuous, faster than aerosol application, and economical at production scale.

In both application modes, the binder is the component that enables the copper particulate coating 230 to the substrate 200 which optionally is corona-treated polyethylene. The binder serves a dual purpose: it holds the copper particles in contact with the panel surface so they remain available for root deterrence, and it slows the dissolution rate of the copper particles by surrounding them with a polymer matrix, extending the medium-term deterrence life of the stage 2 layer 234 and stage 2 interior layer 236.

A feature of the copper particulate coating layer 230 in both application modes is that only a fraction of the copper particles in the dried film are exposed at the film surface at any given time; the majority remain encapsulated within the binder polymer matrix. In a typical dried copper particulate coating film of 10 to 25 micrometers thickness with a copper loading of 2.5 to 10 percent by weight, approximately 1 to 5 percent of the total copper mass is meaningfully exposed at the outer film surface at the time of application. The remaining copper mass is locked inside the binder matrix and is not in direct contact with the soil environment. This partial encapsulation binder acts as a rate-controlling matrix extending the effective deterrence life from weeks to the years-to-decades service life required for the barrier application.

The composition percentages by weight are preferably optimized for allowing physical mechanisms progressively to expose additional copper over the desired service life of the barrier. The exposed surface fraction is self-renewing when root exudate acids dissolve the surface-exposed copper particles into Cu²⁺ ions, and voids open in the binder film where those particles previously sat. These voids allow moisture and acids to penetrate slightly deeper into the film, exposing the next layer of previously encapsulated copper particles to the soil environment. Acrylic, alkyd, and polyurethane binders are slightly permeable to water vapor and dissolved ions over long exposure times. Cu²⁺ ions generated from surface-exposed copper particles migrate outward through the binder film by slow ionic diffusion, and hydrogen ions from root exudates migrate inward to attack encapsulated particles. This bidirectional diffusion is slow relative to the timescale of single-season exposure but accumulates over years of service. At the binder-substrate interface between the copper particulate coating layer 230 and the activated surface layer 242 of the polyethylene substrate 200, microstructural discontinuities and micro-cracks present copper particles at a two-sided surface rather than fully embedding them. These interfacial copper particles contribute disproportionately to the active copper flux because they have two faces available for dissolution.

As a final optional step in both the aerosol spray can application mode and the air-spray gun application mode, after the copper particulate coating layer 230 has fully cured on the polyethylene substrate 200, a copper wool abrading member 248 can be drawn across the cured copper particle coating surface under light pressure to abrade an outermost binder skin and expose a higher fraction of copper particles at the film surface. This produces the abraded surface zone 249 at the outer face of the copper particulate coating layer 230 in which the ratio of exposed copper to binder at the surface is substantially higher than in the as-sprayed film. Copper wool is a commercially available product consisting of fine copper wire fibers typically 0.02 to 0.15 millimeters in diameter. In this abrasion step, the copper wool is used not to deposit copper onto bare polyethylene, but rather to wear down the top layer of already-cured copper particulate coating film in which copper particles are already present and already adhered. The cured acrylic, alkyd, or polyurethane binder has a surface hardness comparable to the copper wool fibers, with both falling in the approximate Mohs hardness range of 2 to 3. Because the binder and the abrading fibers are of comparable hardness, and because the copper particles embedded within the binder are harder than the binder matrix, the copper wool fibers preferentially remove the binder polymer from the surface while leaving the embedded copper particles largely in place. After abrasion and wiping away the copper particulate coating dust, the previously-encapsulated copper particles in the outermost several micrometers of the film are now exposed at the surface, immediately accessible to root exudate attack.

An additional benefit of the copper wool abrading step is that copper metal fragments worn from the copper wool fibers during abrasion deposit into the roughened, freshly-exposed copper particulate coating surface. The abraded binder surface, having micro-scored texture from the wool fibers, retains these deposited copper fragments mechanically. The copper wool step thus simultaneously exposes previously-encapsulated copper from the copper particulate coating and deposits additional copper from the wool, both contributing to increased active copper at the barrier surface.

The copper wool abrading member 248 is preferentially applied to the portions of the panel that will face the root-contact zone, including the micro-ridge surface architecture 202 of the interior soil-facing surface and the interior faces of the first notch and groove connector 34 and the second notch and groove connector 35 that will face inward after interlocking. The copper wool step is optional and may be omitted when the as-sprayed copper particulate coating layer provides sufficient deterrence for the intended installation environment.

As seen in FIG. 7, the copper particulate coating layer 230 is applied to the polyethylene substrate 200 of the panel 20. For example, spray-applied layers 230 may provide a three-stage temporal copper release profile in addition to any nanoparticles in the substrate. The copper particulate coating layer 230 can include a multistage laminate layer. The polyethylene substrate 200 provides structural integrity for the root barrier panel. Above that the encapsulated nanoparticle layer 238 is optionally applied to the polyethylene substrate. The encapsulated nanoparticle layer may have a mixture of high-density polyethylene and a low-density polyethylene, where the polyethylene forms a matrix for encapsulating the nanoparticle layer. Optionally the nanoparticle layer can be or include large particles such as copper grains or dust. The activated surface layer 242 can be applied over the polyethylene substrate 200 and the chitosan chelation layer 232 can be applied to the activated surface layer 242. Finally, the binder matrix layer 234 is preferably applied above the chitosan chelation layer 232. In a differing environments some of these layers are preferred and some of these layers are not. Therefore, the person of ordinary skill in the art can choose to apply one or more of these layers to the polyethylene substrate 200.

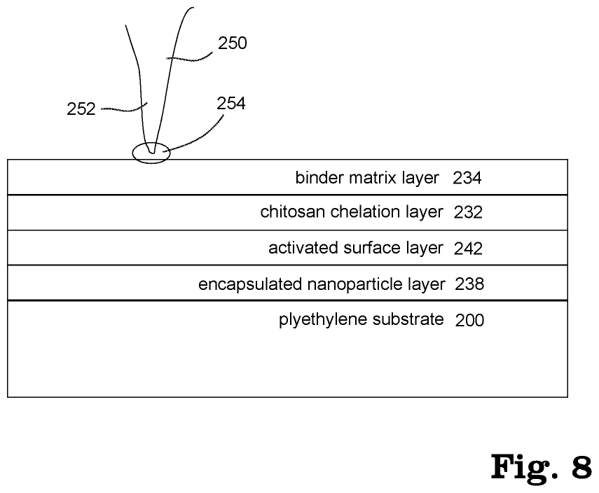

As seen in FIG. 8, for example, the chitosan chelation layer 232 may be applied to the corona-treated surface or bare polyethylene substrate 200 and comprises a copper sulfate or copper acetate solution at 0.1 to 0.5 molar overcoated with a chitosan solution at 2 to 5 percent weight per volume in 1 percent acetic acid, which chelates the ionic copper at the surface and forms a pH-labile film upon drying. When a root tip 250 approaches the panel and secretes organic acids that lower the rhizosphere pH below 5.5 at the rhizosphere acidification zone 254, the chitosan film of the chitosan chelation layer 232 dissolves and releases ionic copper at the root meristematic zone 252 within hours to days of root contact.

The binder-matrix layer 234 on the exterior surface and the binder-matrix interior layer 236 on the connector surfaces comprise the copper particulate coating formulation described above, such as copper particles in acrylic, alkyd, or polyurethane binder, which provide sustained metallic copper dissolution over months to years as root exudate acids at the panel surface progressively dissolve the copper particles exposed at the binder film surface. The encapsulated nanoparticle layer 238, represented by the copper oxide nanoparticles 220 distributed within the polyethylene substrate 200, provides long-term sustained copper ion release over years to decades as the chitosan-alginate polyelectrolyte complex encapsulant 222 dissolves progressively in response to sustained rhizosphere acidification. Because encapsulant dissolution requires sustained pH below 5.5, the encapsulated nanoparticle reservoir is conserved during periods of no root challenge. The chitosan chelation layer 232, binder-matrix layer 234, binder-matrix interior layer 236, and encapsulated nanoparticle layer 238 operate by independent release mechanisms and may be applied in any order, in any combination, and at any position in the cross-section of the panel, including configurations in which the encapsulated nanoparticle layer 238 is disposed within the substrate, over the substrate, or interposed between the chitosan chelation layer 232 and the binder-matrix layer 234.

Additionally, the root tip 250 has a root meristematic zone 252 with a rhizosphere acidification zone 254 that may contact the abraded surface zone with exposed copper 249 of the copper particulate coating layer 230 to activate the chitosan-alginate polyelectrolyte complex encapsulant 222 of the activated surface layer 242. Alternatively instead of layers, the different construction structures can be mixed together so that for example the chitosan chelation layer 232 and binder-matrix layer 234 can be mixed together to form the copper particulate coating layer 230. Preferably the binder matrix layer 234 will have a variety of different copper particulates suspended in the binder matrix layer and some of these can be exposed mechanically through sanding or can be exposed through natural weathering.

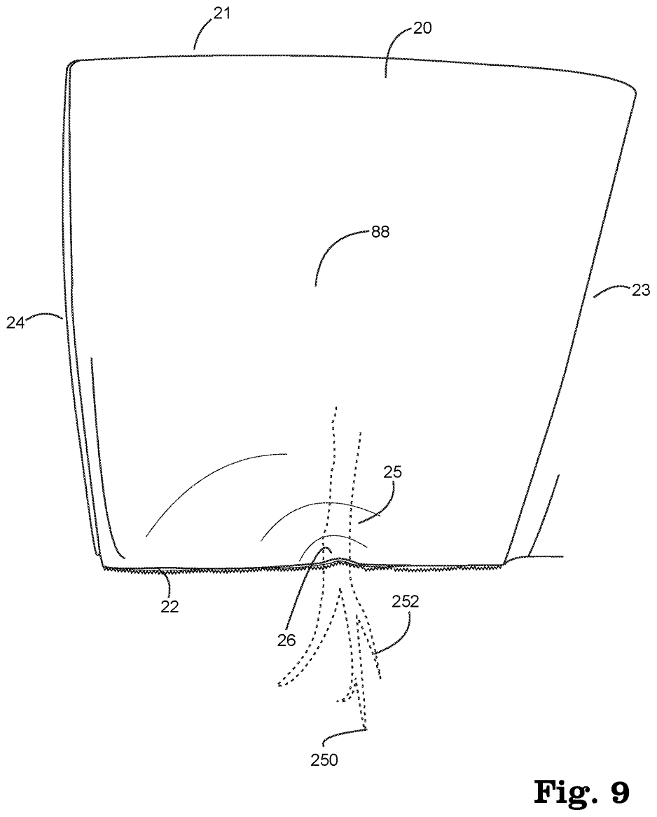

As seen in FIG. 9, the panel lower edge 22 is shown undergoing deformation 26 as the tree root 128 grows beneath the flexible bottom portion 25. The deformation anchors the panel 20 against upward migration. The micro-ridge surface architecture 202 and the copper particulate coating layers 232, 234, and 236 extend along the full soil-facing surface and connector surfaces of the panel 20 including the flexible bottom portion 25, so that copper deterrence is present at the lower panel edge where root challenge is most concentrated.

An exemplary manufacturing method may include the polyethylene substrate 200 formulated as a single-layer flexible panel comprising at least 40 percent low-density polyethylene by weight, at least 40 percent high-density polyethylene by weight, and at least 2 percent carbon black by weight, together providing the required leaf spring flexibility and UV resistance. Copper oxide nanoparticles 220 at 0.5 to 3.0 percent by weight, pre-encapsulated in chitosan-alginate polyelectrolyte complex encapsulant 222, are compounded into the polyethylene melt before extrusion. Calcium carbonate filler at 5 to 15 percent by weight is optionally included to create micro-scale surface roughness that further improves binder adhesion at the activated surface layer 242.

For inline manufacturing, the production sequence includes the steps of: (1) extrude the panel with rib geometry and micro-ridge surface architecture 202; (2) pass the panel surface under corona discharge electrode 240 to produce activated surface layer 242; (3) apply the stage 1 chitosan-copper sulfate spray layer 232 by air-spray gun applicator 246; (4) apply the stage 2 copper particulate coating spray layer 234 and 236 to both exterior and interior surfaces by air-spray gun applicator 246; (5) allow solvent flash-off in a ventilated tunnel; (6) optionally pass the cured panel surface under a copper wool abrading applicator 248 to produce abraded surface zone 249 with increased exposed copper fraction; (7) wind the finished copper-treated panel onto the storage roll. For job-site application to pre-manufactured panels, the sequence of steps is preferably to: (1) unroll and cut panels to length; (2) apply stage 1 and stage 2 copper particulate coating to both exterior surface and interior connector surfaces using aerosol spray can applicator 244; (3) allow to dry; (4) optionally abrade the dried surface with a hand-held copper wool pad to expose additional copper; (5) install and interlock panels in the conventional manner.

The chitosan chelation layer 232 may be copper sulfate with chitosan binder. The binder-matrix layer 234 is a copper particulate coating for the exterior surface and can be an emulsion applied wet. The binder-matrix interior layer 236 can be a copper particulate coating with an interior connector surface. The encapsulated nanoparticle layer 238 preferably includes encapsulated CuO nanoparticles in a substrate.

The barrier is suitable for installation in urban landscaping adjacent to sidewalks, curbs, driveways, building foundations and also in agricultural applications such as for protection of irrigation trenches and drainage channels. In infrastructure protection such as lining of utility trenches and sewer line easements and in green roof and living wall root containment the barrier can contain invasive species such as bamboo, Japanese knotweed, and other rhizome-spreading species.

1. A root barrier comprising:
a. an outer panel;
b. an inner panel, wherein the inner panel has an inner panel middle warp, wherein the inner panel has a copper particulate coating layer deposited on the corona-treated surface by spray application, the copper particulate coating layer comprising copper particles at 2.5 to 10 percent by weight suspended in a polymer binder dissolved in an organic solvent carrier; and wherein the polymer binder, upon solvent evaporation, forms a cured film that encases a majority of the copper particles such that a surface fraction of the copper particles is exposed at the film surface at the time of application;
c. an inner panel lower edge and an inner panel upper edge formed on the inner panel;
d. an inner panel right edge, and an inner panel left edge formed on the inner panel;
e. an inner panel right rib formed on the inner panel right edge and an inner panel left rib formed on the inner panel left edge, wherein the inner panel right rib is formed as a first pinch rib and wherein the inner panel left rib is formed as a second pinch rib, wherein the first pinch rib and the second pinch rib are both configured to connect with the outer panel, wherein the outer panel and the inner panel form a panel overlap, wherein the inner panel middle warp biases the first pinch rib and the second pinch rib into engagement with the outer panel; and
f. a parallel portion formed along the panel overlap, wherein the parallel portion has a panel gap, wherein the inner panel right rib forms a first inner pinch retainer, and wherein a panel left rib forms a second inner pinch retainer, wherein the first inner pinch retainer is formed as a first notch and groove connector, wherein the second inner pinch retainer is formed as a second notch and groove connector.

2. The root barrier of claim 1, wherein the inner panel is flexible and acts as a leaf spring, wherein the inner panel middle warp is resilient and can be flattened along the panel overlap when compressed together in an installed mode.

3. The root barrier of claim 1, wherein the inner panel is formed with a flexible panel lower edge.

4. The root barrier of claim 1, wherein the inner panel is configured to deform when a root grows under the inner panel.

5. The root barrier of claim 1, wherein the inner panel is formed of at least 40% low-density polyethylene by weight, 40% high density polyethylene by weight, and at least 2% carbon.

6. The root barrier of claim 1, wherein the inner panel right rib is V-shaped and the panel left rib is also V-shaped.

7. The root barrier of claim 1, wherein the outer panel further comprises:
a. an outer panel middle warp;
b. an outer panel lower edge and an outer panel upper edge formed on the outer panel;
c. an outer panel right edge, and an outer panel left edge formed on the outer panel; and
d. an outer panel right rib formed on the outer panel right edge and an outer panel left rib formed on the outer panel left edge, wherein the outer panel right rib is formed as a first pinch rib and wherein the outer panel left rib is formed as a second pinch rib.

8. The root barrier of claim 1, wherein the inner panel comprises a polyethylene substrate having copper oxide nanoparticles dispersed therein and encapsulated in a chitosan-alginate polyelectrolyte complex encapsulant that releases copper ions at a soil pH below approximately 5.5.

9. The root barrier of claim 8, further comprising a micro-ridge surface architecture formed on a soil-facing surface of the inner panel, the micro-ridge surface architecture having ridges with a ridge height of 0.1 to 2.0 millimeters and a center-to-center spacing of 0.3 to 5.0 millimeters.

10. The root barrier panel of claim 7, wherein the copper particulate coating layer is deposited by an aerosol spray can applicator comprising the copper particulate coating formulation pressurized with a hydrocarbon propellant comprising propane and n-butane.

11. The root barrier panel of claim 7, wherein the copper particulate coating layer is deposited by an air-spray gun applicator without propellant, the copper particulate coating formulation being thinned with an organic solvent to a spray viscosity of 15 to 30 seconds measured in a No. 4 Ford Cup.

12. The root barrier panel of claim 7, wherein the polymer binder is selected from the group consisting of acrylic polymer, alkyd resin, and polyurethane resin, and wherein the organic solvent carrier comprises one or more of toluene, petroleum naphtha, dimethyl carbonate, hydrotreated light distillate, n-heptane, and octane.

13. The root barrier panel of claim 7, wherein the flexible polyethylene substrate comprises a first notch and groove connector and a second notch and groove connector configured to interlock with a corresponding adjacent panel, and wherein the copper particulate coating layer is deposited on interior surfaces of the first notch and groove connector and the second notch and groove connector before the flexible polyethylene substrate is interlocked with the adjacent panel, wherein the flexible polyethylene substrate has a corona-treated surface.

14. The root barrier panel of claim 7, further comprising a stage 1 layer deposited on the corona-treated surface beneath the copper particulate coating layer, the stage 1 layer comprising a copper sulfate or copper acetate solution overcoated with a chitosan binder that releases ionic copper upon rhizosphere acidification below pH 5.5.

15. The root barrier panel of claim 14, wherein the flexible polyethylene substrate further comprises copper oxide nanoparticles dispersed therein and encapsulated in a chitosan-alginate polyelectrolyte complex encapsulant forming a stage 3 layer, the stage 1 layer, the copper particulate coating layer, and the stage 3 layer together providing a three-stage temporal copper release profile delivering immediate copper ion release from the stage 1 layer over hours to days of root contact, medium-term copper release from the copper particulate coating layer over months to years, and long-term sustained copper release from the stage 3 layer over years to decades.

16. The root barrier panel of claim 7, wherein the flexible polyethylene substrate further comprises 5 to 15 percent by weight calcium carbonate filler providing surface roughness that enhances adhesion of the copper particulate coating layer.

17. The root barrier panel of claim 7, further comprising a micro-ridge surface architecture formed on the flexible polyethylene substrate beneath the copper particulate coating layer, the micro-ridge surface architecture having ridges with a ridge height of 0.1 to 2.0 millimeters and a center-to-center spacing of 0.3 to 5.0 millimeters, wherein the copper particulate coating layer extends over ridge faces and into ridge channels between adjacent ridges.

18. The root barrier panel of claim 7, wherein the cured film of the copper particulate coating layer has an abraded surface zone produced by mechanical abrasion of the cured film with a copper wool applicator, wherein the abraded surface zone exposes a higher fraction of copper particles than is exposed in an unabraded portion of the copper particulate coating layer.

19. A method of manufacturing the root barrier panel of claim 7, comprising the steps of:
a. extruding the flexible polyethylene substrate in a continuous roll;
b. subjecting a surface of the flexible polyethylene substrate to corona discharge treatment to raise the surface energy to at least 38 dynes per centimeter and to produce the corona-treated surface;
c. spray-applying the copper particulate coating layer onto the corona-treated surface using one of an aerosol spray can applicator pressurized with propane and n-butane propellant or an air-spray gun applicator without propellant;
d. allowing the organic solvent carrier to evaporate such that the polymer binder cures into a continuous film encasing the copper particles; and
e. optionally abrading the cured film with a copper wool applicator to expose a higher fraction of copper particles at the film surface.
